(19) United States
(12) Patent Application Publication
(10) Pub. No.: US 2012/0096526 A1
(43) Pub. Date: Apr. 19, 2012

(54) FLEXIBLE MODULES FOR VIDEO AUTHENTICATION AND SHARING

(76) Inventors: Syed Saleem Javid Brahmanapalli, Richmond, CA (US); Christopher M. Denend, Menlo Park, CA (US)

(21) Appl. No.: 13/270,464

(22) Filed: Oct. 11, 2011

Related U.S. Application Data
(60) Provisional application No. 61/394,705, filed on Oct. 19, 2010.

(51) Int. Cl. H04L 9/32

(52) U.S. Cl. 726/6

(57) ABSTRACT

A method for managing video authentication and sharing includes storing a playlist of video clips in a storage device, allowing a manager to define a degree of privacy for the playlist by the computer system, defining roles for a plurality of users in relation to the video clips, creating user tokens for the plurality of users according to the respective roles of the users, receiving a user token over a computer network, authenticating the user token and the role of a user associated with the user token, deciding on whether the user has the right to access the playlist of video clips based on the role of the user and the degree of privacy defined for the playlist, and if it is determined that the user has the right to access the playlist, allowing the user to access the playlist of video clips over the computer network.

### CROSS-REFERENCES TO RELATED APPLICATIONS

The present application claims priority to pending U.S. provisional patent application 61/394,705, titled “Flexible modules for video authentication and sharing”, filed by the same inventors on Oct. 19, 2010, the content of which is incorporated herein by reference.

### BACKGROUND OF THE INVENTION

The current video sharing sites allow public sharing of video clips. Users cannot easily manage who is allowed or not allowed to view the video clips. On the other hand, user privacy over the Internet has become a serious issue. Many users have the needs to differentiate the sharing of their video clips: they like to share some video clips to the public while restricting other video clips to be viewed only by their friends and families.

### SUMMARY OF THE INVENTION

The invention system and methods provide flexibility for user to create video playlist using video clips from different contributors.

The invention system and methods also provide flexibility in setting the degree of privacy for the sharing of each video clip or video playlist. The user can define viewable members for a playlist or to make it public.

The presently disclosed system and methods also allow video clips to be easily accessed and managed in different application channels.

In one general aspect, the present application relates to a method for managing video authentication and sharing. The method includes storing a playlist of video clips in a storage device; allowing a manager to define a degree of privacy for the playlist by the computer system; defining roles for a plurality of users in relation to the video clips; creating user tokens for the plurality of users according to the respective roles of the users; receiving a user token over a computer network; authenticating the user token and the role of a user associated with the user token; deciding on whether the user has the right to access the playlist of video clips based on the role of the user and the degree of privacy defined for the playlist; and if it is determined that the user has the right to access the playlist, allowing the user to access the playlist of video clips over the computer network.

Implementations of the system may include one or more of the following. The degree of privacy requires that the playlist of video clips are allowed to be viewed only by a group of users. The degree of privacy can specify that the playlist of video clips are allowed to be viewed by the public. The roles can include a viewer who has the right to view the playlist of video clips, a contributor who has the right to contribute and to view the playlist of video clips, and a manager who has the right to edit, to contribute, and to view the playlist of video clips. The playlist can include video clips recorded by different users. The playlist includes video clips can be recorded by the different users at a common occasion. The method can further include: creating a secure network token for the playlist by a computer system; providing the secure network token to the user to allow the user to access the playlist of video clips over the computer network. The secure network token can include a persistent key which allows persistent access to the playlist of video clips by the user over the computer network. The user can be allowed to access the playlist of video clips using the secure network token via a video streaming site. The user can be allowed to access the playlist of video clips using the secure network token via a web browser. The user can be allowed to access the playlist of video clips using the secure network token via a computer device or a communication device.

In another general aspect, the present application relates to a method for managing video authentication and sharing. The method includes storing a playlist of video clips in a storage device; creating a secure network token for the playlist by a computer system; defining roles of a plurality of users in relation to the playlist; creating user tokens for the plurality of users by the computer system; receiving a user token over a computer network; authenticating the user token and the role of a user associated with the user token; and allowing the user to access the playlist of video clips over the computer network using the secure network token, wherein the user to is allowed to access the playlist in such a way as defined by the role of the user.

Implementations of the system may include one or more of the following. The playlist can include video clips recorded by different users. The playlist can include video clips are recorded by the different users at a common occasion. The roles can include a viewer who has the right to view the playlist of video clips, a contributor who has the right to contribute and to view the playlist of video clips, and a manager who has the right to edit, to contribute, and to view the playlist of video clips. The secure network token can include a persistent key which allows persistent access to the playlist of video clips by the user over the computer network. The user can be allowed to access the playlist of video clips using the secure network token via a video streaming site, via a web browser, or via a computer device or a communication device. The method can further include allowing a manager for the playlist to define a degree of privacy for the playlist. The playlist of video clips can be allowed to be viewed only by a group of users, wherein the user is allowed to access the playlist of video clips only when the user is one of the group of users.

In another general aspect, the present application relates to a method for managing video authentication and sharing. The method includes storing a plurality of playlists each having one or more video clips in a storage device; creating a secure network token for each of the plurality of playlists by a computer system; defining roles for a plurality of users in relation to the video clips; creating user tokens for the plurality of users by the computer system; receiving a request to access one of the plurality of playlists from a user over a computer network; authenticating a user token received from the user by the computer system; and allowing the user to access the one of the plurality of playlists over the computer network using the secure network token, wherein the user's access to the one of the plurality of playlists is according to the role of the user.

### BRIEF DESCRIPTION OF THE DRAWINGS

FIG. 1 is a block diagram of a video share management system in accordance with the present invention.

FIG. 2 is a block diagram for the authentication module of the video share management system as shown in FIG. 1.

FIG. 3 illustrates exemplified applications for the video share management system as shown in FIG. 1.

FIG. 4 illustrates details of a user access control module in FIG. 2.

FIGS. 5 and 6 illustrate details of a video share module in FIG. 1.

Although the invention has been particularly shown and described with reference to multiple embodiments, it will be understood by persons skilled in the relevant art that various changes in form and details can be made therein without departing from the spirit and scope of the invention.

### DETAILED DESCRIPTION OF THE INVENTION

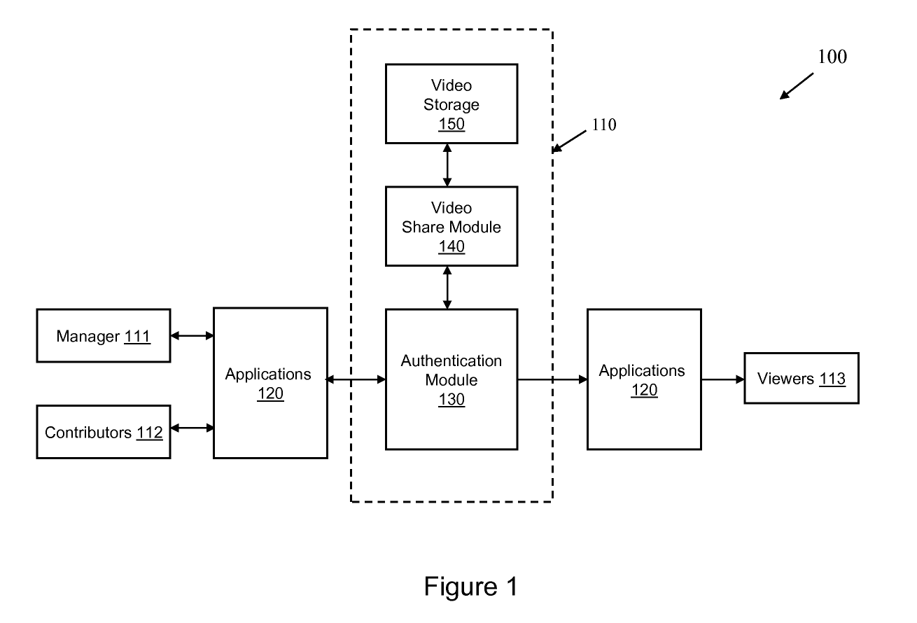

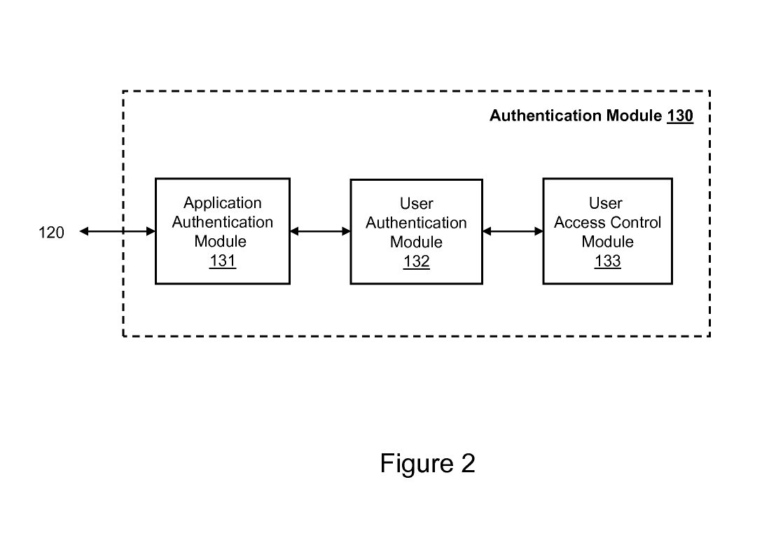

A video share system 100, as shown in FIG. 1, includes a video share management system 110 that can communicate with users such as a manager 111, contributors 112, and viewers 113 via applications 120. The video share management system 110 includes an authentication module 130, a video share module 140, and a video storage 150. The authentication module 130 further includes, as shown in FIG. 2, an application authentication module 131, a user authentication module 132, and a user access control module 133.

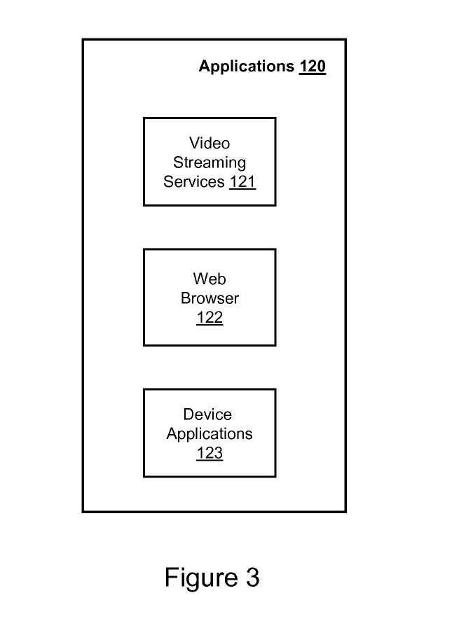

Users of the video share management system 110 can have different roles such as manager 111, contributors 112, and viewers 113. Users communicate with the video share management system 110 via applications 120 which can stream video clips from the video share management system 110 and present the video clips to users on display devices. Applications 120, shown in FIG. 3, can reside in different channels or on different platforms, such as video streaming services 121 (e.g. Roku), web browsers 122 that can access video hosted by sites like Shutterfly, Inc., and device applications 123 installed on computer or communication devices such as smart phones, IPAD, etc.

Users communicating with the video share management system 110 are to be authenticated by the user authentication module 132 and receive user tokens. The user tokens are created by the user authentication module 132 according to users' respective roles. Contributors 112 can send video clips to the video share management system 110 and to be stored in the video storage 150. A manager 111 (or administrator) can organize video clips and manage the distribution of video clips. Video clips can be assembled in a playlist to be presented to viewers via application 120 in accordance to the control of the manager 111.

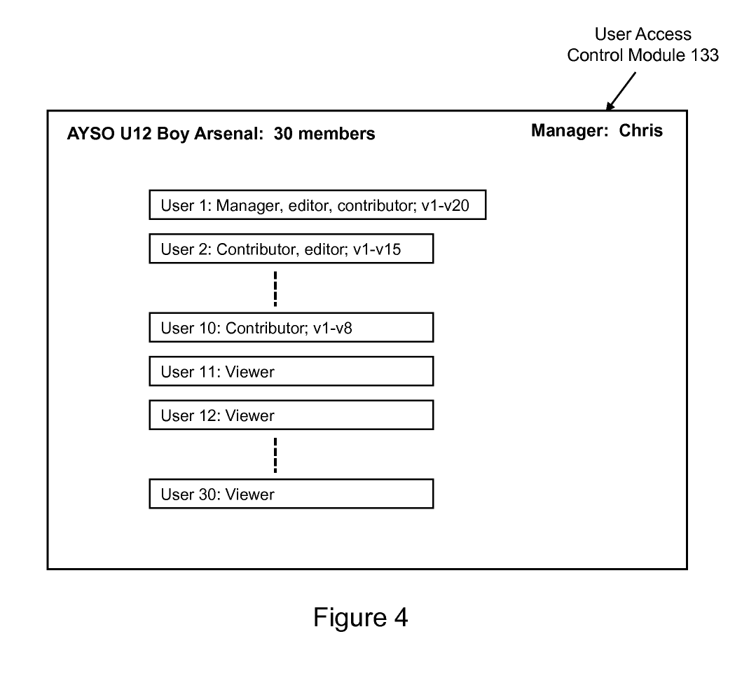

The user access control module 133, referring to FIG. 4, allows the manager 111 (i.e. the administrator) to define the roles of a group of users for video sharing group. For example, a video sharing group can be set up for a soccer team “AYSO U12 Boy Arsenal”, which includes 30 members and is managed by a soccer dad Chris. The user access control module 133 can support a user interface to show Chris a list users user 1, user 2, . . . user 30 in the video share group, and allow Chris to define the roles of each user. For example, user 1 can be Chris himself who is a manager, is allowed to edit video or caption content, to contribute, and view. User 1 may a contributor who has contributed 20 video clips v1-v20 from different soccer games and other team events. User 2 can be another soccer parent named Saleem who has editing rights and also is a contributor of video clips v1-v15. Similarly, user 10 is a contributor of 8 video clips. Users 11-30 are viewers who are authorized to view the view clips captured for Team Arsenal, but are not contributors or editors. The video clips from different contributing users are stored in the video storage 120. User identities and their roles are also stored in the video share management system 110, which are to be used for user authentication and the control of the video sharing distribution.

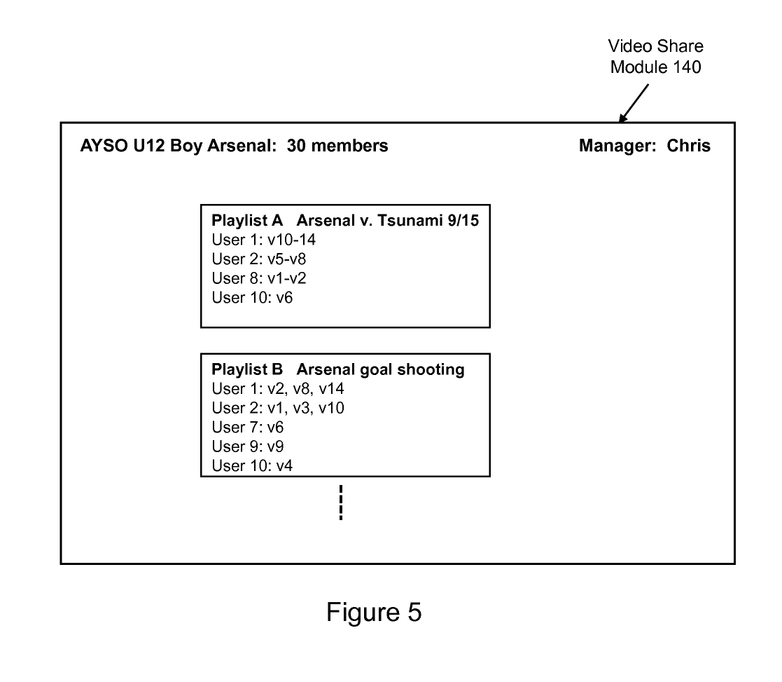

The video share module 140, referring to FIG. 5, allows the manager 111 to manage the distribution of video clips for a group of users. The manager 111 can flexibly assemble video clips from different contributors into different playlists. For example, Playlist A can include a video clip recorded at a specific game played by Team Arsenal against another team Tsunami. The manager can review and edit video clips, and add recording time and other information (e.g. names for different player numbers) to go into Playlist A. The manager can also create a Playlist B that highlights goal shooting scenes by Team Arsenal. Playlist B can include video clips recorded at different games.

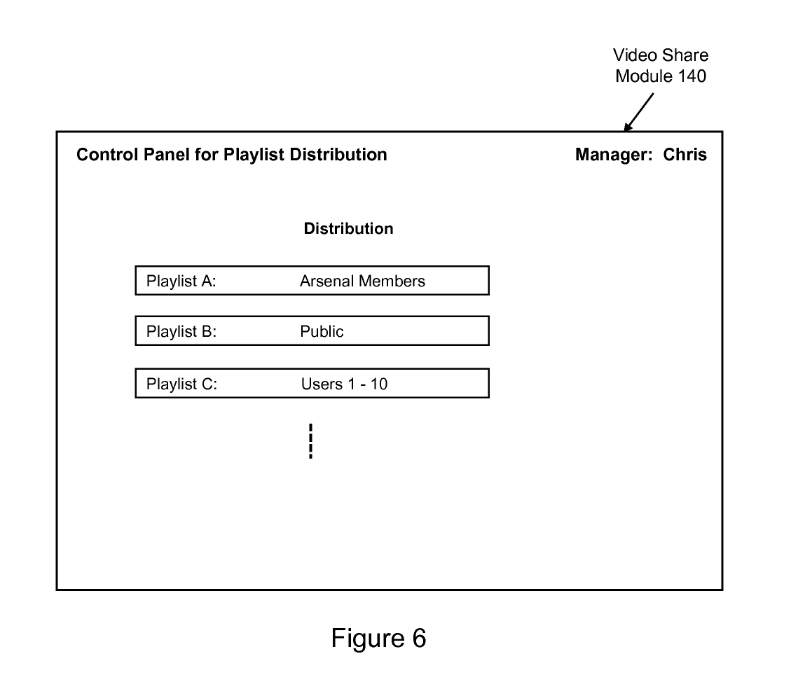

In some embodiments, the video share module 140 allows the manager 111 to define the degree of privacy in the distribution and sharing for each playlist (or video clip). For example, as shown in FIG. 6, the manager 111 can define Playlist A to be viewable by all and only the Arsenal members (i.e. user 1-user 30). Playlist B can be made public to all users on the Internet. Playlist C can be made viewable to only a subgroup (e.g. users 1-10) of the Arsenal members.

Once a playlist is created, the video share module 140 creates a secure network token for the playlist to allow the playlist to be shared over a computer network. The token for the playlist can be a persistent key which provides a consistent and reliable way for users (viewers, contributors, or manager) to set up communications with the video share management system 110 using the respective user tokens (authenticated by the user authentication module 132, as described above).

To view a playlist, a viewer 113 operates a device to send a request to the video share management system 110. The application authentication module 131 identifies the user token and the secure network token of the playlist that the viewer 113 intends to access. The application authentication module 131 authenticates the application channel (121-123). The user authentication module 132 authenticates the user token. The user access control module 133 authenticates the role of the viewer (viewing, contributing, editing etc.). If the user is allowed to access the playlist according to the predefined privacy control, the video content in the playlist is streamed to the viewer 113 according to the user's role (in the video sharing group and specific to the video sharing) defined in the user access control module 133.

Different users can access the playlist using their respective authenticated user tokens from different application channels. For example, a manager can use a tablet computer such as IPAD or a smart phone to access the video share management system 110 to manage the video sharing in the video sharing group. The manager can view video clips in the playlist using a web browser on a personal computer. Since the token for the playlist is persistent, the manager can access, view, or manage the video share management system 110 using his user token regardless which application channel he uses.

Each communication session can time out, for example, in one day or two days. The user tokens and the playlist tokens are persistent, which allows flexibility for the users to access the video share management system 110 at different times and using many different methods at the convenience to the users.

What is claimed is:

1. A method for managing video authentication and sharing, comprising:
storing a playlist of video clips in a storage device;
allowing a manager to define a degree of privacy for the playlist by the computer system;
defining roles for a plurality of users in relation to the video clips;
creating user tokens for the plurality of users according to the respective roles of the users;
receiving a user token over a computer network;
authenticating the user token and the role of a user associated with the user token;
deciding on whether the user has the right to access the playlist of video clips based on the role of the user and the degree of privacy defined for the playlist; and
if it is determined that the user has the right to access the playlist, allowing the user to access the playlist of video clips over the computer network.

2. The method of claim 1, wherein the degree of privacy requires that the playlist of video clips are allowed to be viewed only by a group of users.

3. The method of claim 1, wherein the degree of privacy specifies that the playlist of video clips are allowed to be viewed by the public.

4. The method of claim 1, wherein the roles include a viewer who has the right to view the playlist of video clips, a contributor who has the right to contribute and to view the playlist of video clips, and a manager who has the right to edit, to contribute, and to view the playlist of video clips.

5. The method of claim 1, wherein the playlist includes video clips recorded by different users.

6. The method of claim 5, wherein the playlist includes video clips recorded by the different users at a common occasion.

7. The method of claim 1, further comprising:
creating a secure network token for the playlist by a computer system; and
providing the secure network token to the user to allow the user to access the playlist of video clips over the computer network.

8. The method of claim 7, wherein the secure network token includes a persistent key which allows persistent access to the playlist of video clips by the user over the computer network.

9. The method of claim 7, wherein the user is allowed to access the playlist of video clips using the secure network token via a video streaming site.

10. The method of claim 7, wherein the user is allowed to access the playlist of video clips using the secure network token via a web browser.

11. The method of claim 7, wherein the user is allowed to access the playlist of video clips using the secure network token via a computer device or a communication device.

12. A method for managing video authentication and sharing, comprising:
storing a playlist of video clips in a storage device;
creating a secure network token for the playlist by a computer system;
defining roles of a plurality of users in relation to the playlist;
creating user tokens for the plurality of users by the computer system;
receiving a user token over a computer network;
authenticating the user token and the role of a user associated with the user token; and
allowing the user to access the playlist of video clips over the computer network using the secure network token, wherein the user to is allowed to access the playlist in such a way as defined by the role of the user.

13. The method of claim 12, wherein the playlist includes video clips recorded by different users.

14. The method of claim 13, wherein the playlist includes video clips are recorded by the different users at a common occasion.

15. The method of claim 12, wherein the roles include a viewer who has the right to view the playlist of video clips, a contributor who has the right to contribute and to view the playlist of video clips, and a manager who has the right to edit, to contribute, and to view the playlist of video clips.

16. The method of claim 12, wherein the secure network token includes a persistent key which allows persistent access to the playlist of video clips by the user over the computer network.

17. The method of claim 12, wherein the user is allowed to access the playlist of video clips using the secure network token via a video streaming site, via a web browser, or via a computer device or a communication device.

18. The method of claim 12, further comprising:
allowing a manager for the playlist to define a degree of privacy for the playlist.

19. The method of claim 18, wherein the playlist of video clips are allowed to be viewed only by a group of users, wherein the user is allowed to access the playlist of video clips only when the user is one of the group of users.

20. A method for managing video authentication and sharing, comprising:
storing a plurality of playlists each having one or more video clips in a storage device;
creating a secure network token for each of the plurality of playlists by a computer system;
defining roles for a plurality of users in relation to the video clips;
creating user tokens for the plurality of users by the computer system;
receiving a request to access one of the plurality of playlists from a user over a computer network;
authenticating a user token received from the user by the computer system; and
allowing the user to access the one of the plurality of playlists over the computer network using the secure network token, wherein the user's access to the one of the plurality of playlists is according to the role of the user.
